(19) United States
(12) Patent Application Publication
(10) Pub. No.: US 2010/0024738 A1
(43) Pub. Date: Feb. 4, 2010

(54) HUMMINGBIRD FEEDER

(75) Inventors: David W. CHEN, Lewis Center, OH (US); Leighton L. Chen, Lewis Center, OH (US)

Correspondence Address: STANDLEY LAW GROUP LLP, 6300 Riverside Drive, Dublin, OH, 43017, US

(73) Assignee: AMERIHUA INTERNATIONAL ENTERPRISES INC., Lewis Center, OH (US)

(21) Appl. No.: 12/533,132

(22) Filed: Jul. 31, 2009

Related U.S. Application Data
(60) Provisional application No. 61/085,292, filed on Jul. 31, 2008.

(51) Int. Cl. A01K 7/00; A01K 39/02

(52) U.S. Cl. 119/72

(57) ABSTRACT

The present invention discloses an innovative hummingbird feeder. The feeder of the present invention is comprised of a main body, a stopper for the main body and several feeding port assemblies. The present invention allows the consumer to engage stoppers at each feeding port assembly, these stopper prevent spillage during refilling of the nectar reservoir. Additionally, the feeding port assemblies allow access to hummingbirds but prevent access by pests, while presenting a flower-like appearance to the birds.

### CROSS-REFERENCE TO RELATED APPLICATIONS

This application is a non-provisional patent application of U.S. Application No. 61/085,292 filed Jul. 31, 2008 and is hereby incorporated by reference.

### TECHNICAL FIELD

The present invention relates to bird feeders, and more particularly to feeders designed for hummingbirds.

### BACKGROUND OF THE ART

Feeders of the past suffer from significant drawbacks due to pests, and difficulties associated with cleaning and refilling the feeders. Hummingbird feeders attract hummingbirds through the use of nectar or a sugar solution, which the hummingbirds consume. The hummingbirds can smell the food solution from a significant distance and are naturally attracted to it as an easy source of food. However, pests such as ants and bees are attracted to the feeders in much the same way.

Attracting insect-pests has many drawbacks. Attracting ants has a mainly aesthetic downside of the ants becoming stuck while extracting the feed solution, and creating an unsightly mess—necessitating more frequent cleaning of the feeder. Attracting bees is more a problematic issue; first the bees will bother observers and detract from the experience of observing the hummingbirds. Second, the bees will tend to frighten off the hummingbirds that are attracted to the feeder, making it useless for its intended purpose.

Many feeders of the past have screw-top lids, screw-on bottom bases or have several components which must be removed in order to replenish the feed solution, often necessitating removing the feeder from the tree on which it is hanging, any of these can make the process of refilling the feed a time consuming process. Often, even while going through the time-consuming process of accessing the feeder's reservoir to refill the solution, the solution is likely to spill due to the reservoir having an opening that is difficult to access. Additionally, in order to prevent the feed solution from spilling on the ground and attracting more pests, feeders of the past employed trays that hang under the main body of the feeder to collect feed solution should it overflow. These trays will often spill when the feeder is refilled, eliminating the advantage gained by having the collection tray.

### SUMMARY OF THE INVENTION

The present invention is directed toward eliminating the problems illustrated above. In order for a hummingbird feeder to perform its intended function of attracting and re-attracting hummingbirds, the birds need not only to smell the solution, but must also be able to consume the solution. Hummingbirds do this via their long straw-like beaks. However, pests like bees utilize similar appendages to consume the solution. It is an advantage of the present invention that the access ports for the hummingbirds to consume the feed solution are shallow enough that the hummingbirds can access the solution without issue, but long enough that the bee's proboscis cannot reach, and narrow such that the bees or ants cannot crawl down to the solution. Because of this innovation the top-fill feeder disclosed herein may be used in areas that have bees or ants nearby without attracting pests like feeders of the past.

The access ports of the present invention also include stoppers that are attached to each access aperture by a collar that is engaged by the access tube. The stoppers, when engaged, allow the consumer to fill the feeder without risking spilling the feed solution requiring messy clean-up or the risk of attracting pests.

The design of the present invention makes refilling the feed solution much easier. The main body of the feeder is generally shaped like a shaft and globe type bottle, with a long, hollow neck leading down to a substantially globular reservoir with access apertures arranged about the reservoir portion of the body. The shaft is open at the top for easy access to the reservoir. The apparatus includes a stopper that seals the top of the shaft such that no pests can access the reservoir from the top, but is designed such that it is easily removed for quick refilling.

The access apertures include several components and are designed such that they function for their intended purpose and also provide a flower-like appearance for the access apertures. The flower-like appearance facilitates attraction of the hummingbirds.

This and other unmet needs of the prior art are met by a device as described in more detail below.

### BRIEF DESCRIPTION OF THE DRAWINGS

A better understanding of embodiments of the present invention will be had when reference is made to the accompanying drawings, wherein identical parts are identified with identical reference numerals, and wherein:

FIG. 1 is a cross section view of an exemplary hummingbird feeder.

FIG. 2 is a perspective view of an exemplary feeder, with the stopper for the neck portion removed.

FIG. 3a-h are side and perspective view illustrations of the components of the feeding port assembly.

### DETAILED DESCRIPTION OF THE DRAWINGS

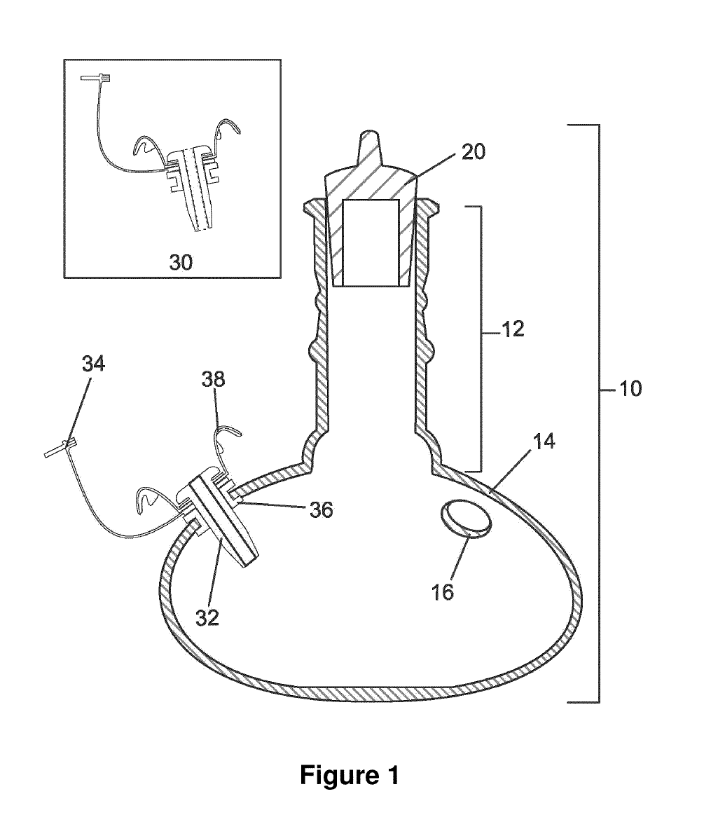

Turning now to the drawings for a better understanding, FIG. 1 illustrates an embodiment of the hummingbird feeder 10, including: a neck portion 12; a globular reservoir 14; a plurality of access apertures 16, disposed on the reservoir; a rubber stopper 20, a feeding port assembly 30, operationally inserted into each hole 16, such that the assembly is operative to dispense nectar to hummingbirds. It is clear from the drawings that the main body of the feeder 10 is comprised of a vessel (e.g. a glass bottle) including a hollow neck portion 12, disposed on top of and in fluid communication with a reservoir portion. The neck portion is open at one end to facilitate replenishing the feeding solution. Preferably, the feeder is suspended via a support means that allows the feeder to be tilted for refilling the feed solution. The feeder also includes a rubber stopper 20, to close off the top of the neck portion in order to prevent pests from entering or debris falling into the reservoir via the neck, reducing the frequency of cleaning. The rubber stopper 20 causes a vacuum to form which helps retain the feeding solution in the feeder. Said another way, the rubber stopper prevents the contents of the feeder from freely flowing through the apertures.

The neck portion 12 may be longer or shorter than shown in the embodiment of FIG. 1 depending on individual design preference. Furthermore, the rubber stopper 20 may in fact be constructed from any suitable material or may be replaced by a screw-on cap or other suitable structure for covering or closing the open end of neck portion 12. In instances where a screw-on cap is used, neck portion 12 may be configured with screw threads either on its exterior or on its interior to mate with corresponding threads on the screw-on cap.

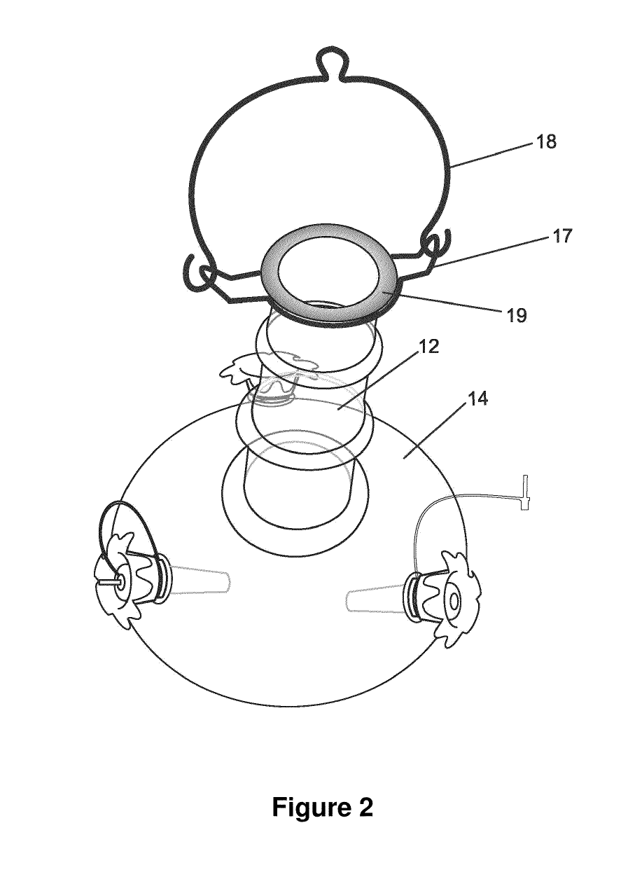

FIG. 2 is a perspective view of an embodiment of the present invention. The perspective view illustrates the opening near the top of the neck portion. Additionally it is clear that the imitation flower assemblies 30, are arranged in a substantially symmetrical fashion about the neck 12, of the main body. Additionally, FIG. 2 illustrates the operational coupling of the stopper and the access tube.

Many consumers display their hummingbird feeders off the ground suspended from tree limbs, or flower basket supports etc, to increase the visibility of the feeder to birds and observers alike. In response to this; the present invention also includes a hanger. FIG. 2 depicts an embodiment of a hanger for a hummingbird feeder. In an embodiment of the present invention, the hanger comprises a 2 wire assembly. As is clear from the drawings, the first wire 17 acts as a collar that fits around the neck portion, and serves to hold the feeder below its uppermost lip 19. The second wire 18 is a loop that serves as a connection from the collar 17 to whatever the hummingbird feeder will be suspended from. Those skilled in the art will recognize many ways to suspend a hummingbird feeder such as the present invention; as such the preceding description is made merely for illustration and should not be construed to limit the present invention to the specific elements described.

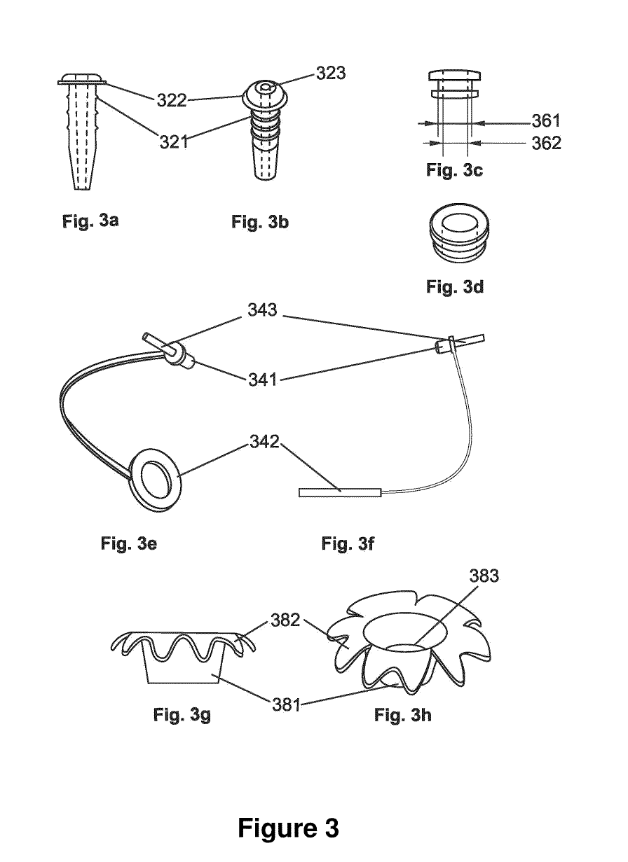

The feeding port assembly 30, is comprised of 4 components, namely a stem portion 32; a grommet 36, for creating a seal between the stem portion and the reservoir 14; a stopper unit 34; and an imitation flower 38. As can be observed from FIG. 3, the stem portion is substantially a tube. Along the neck of the tube the stem portion is adapted with raised rings 321, to facilitate the coupling between the stem portion and the respective grommet 36. The top of the stem portion includes a ring 322, with a wider diameter than the main body of the tube; this is to aid the stem portion in engaging the imitation flower and the collar for the stopper unit 34, additionally the increased diameter prevents the stem portion from falling through the access apertures 16, during reassembly. The holes in the globular reservoir are angled such that the stem portion is directed substantially into the feed solution. The inner diameter of the stem-portion tube 323, is wide enough to accommodate the beak of a hummingbird, yet narrow enough to prevent bees or other insects from crawling down into to reservoir. Additionally the length of the stem portion should allow the hummingbirds to access the nectar with their beaks, while preventing pests from using similar means to feed.

The grommet (depicted as 36 and FIGS. 3c and 3d) is comprised of any of the common materials that liquid seals are constructed from, including but not limited to plastics, natural rubber, and synthetic rubbers. The grommet is adapted to provide a seal between the stem portion and the respective hole disposed on the reservoir. The grommet has an outer diameter 361 that is substantially the same as the diameter of the hole in the reservoir, and an inner diameter 362 such that the stem portion can be inserted to allow fluid communication through the stem portion, while preventing leakage around the outer surface of the stem portion.

The stopper unit (depicted as 34 and FIGS. 3e and 3f) may be comprised of plastic or other suitable material and includes a stopper 341, operationally connected to a collar 342. The stopper has a diameter that, when operationally engaged with the stem portion 32, prevents the nectar from leaking or spilling during refilling or transport. The stopper also has a handle 343, for disconnecting the stopper from the stem portion. The collar 342 is comprised of the same material as the stopper, and is substantially a flattened ring with an inner and outer diameter. The inner diameter is smaller than the outer diameter, and is wide enough that it can be slid around the tube of the stem portion, but is smaller than the diameter of the top portion of the tube. Operationally, when the collar is engaged with the stem portion and the stem portion is operationally inserted into the grommet, the collar keeps the stopper in close proximity to the stem portion.

The imitation flower (depicted as 38 and FIGS. 3g and 3h) is comprised of similar material to that of the stopper unit and the stem portion. The imitation flower includes a base 381, which is frusto-conical in shape, and a plurality of imitation flower petals 382, arrayed in imitation of a flower. Additionally, the imitation flower is a color similar to naturally occurring flowers to support the illusion that the hummingbirds are feeding from a natural flower. Preferably the flower is red. The lower portion of the base is adapted with a hole 383, to insert the stem portion through. The diameter of the hole is such that the stem portion 32 may be directed through it during reassembly, but the hole is smaller than the ring 322, at the top of the stem portion. Operationally, when the stem portion 32, is inserted through the hole in the imitation flower, and the stem portion is then engaged with grommet 36, the ring of the stem portion 322, will hold the imitation flower 38, in place.

Having shown and described embodiments of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

1. A hummingbird feeder comprising:
a main body; said main body comprising a reservoir and a hollow neck portion arranged substantially as a shaft and globe-type bottle; said neck portion being open at the top; said reservoir having at least one access aperture disposed thereon;
a stopper for sealing the opening atop the neck portion;
at least one feeding port assembly; and
a hanger.

2. The hummingbird feeder of claim 1, wherein the main body is comprised of glass; and the stopper is comprised of rubber.

3. The hummingbird feeder of claim 1, wherein the feeding port assembly comprises:
an access tube; said access tube is in liquid communication with the reservoir; wherein the access tube is comprised of a main tube portion and a retaining portion, said retaining portion positioned at the top of the access tube, and having a larger diameter than the access tube;
an imitation flower; wherein the imitation flower includes a base and a plurality of imitation flower petals arrayed on the base, the base has a hole disposed thereon, the hole having a diameter larger than the main tube portion of the access tube, but smaller than the retaining portion, and through which is inserted the access tube to provide access to the reservoir with a substantially flower-like appearance;
a stopper adapted to close off the entrance of the access tube while engaged, said stopper is connected to the access unit by a collar, wherein said access tube is inserted through the collar and the collar for the stopper is engaged by the access tube via the retaining portion; and
a grommet; wherein the grommet is in operational contact with both the access tube and the at least one access aperture of the reservoir, preventing leakage.
